(19) United States
(12) Patent Application Publication
(10) Pub. No.: US 2013/0255064 A1
(43) Pub. Date: Oct. 3, 2013

(54) INDUSTRIAL-PIPING SYSTEM ATTACHMENT DEVICES FOR SEISMIC BRACING AND METHODS OF USE

(71) Applicant: Thomas W. McMahon, Steamboat Springs, CO (US)

(72) Inventor: Thomas W. McMahon, Steamboat Springs, CO (US)

(21) Appl. No.: 13/384,507

(22) PCT Filed: Dec. 20, 2010
(86) PCT No.: PCT/US10/61352

§ 371 Date: Jan. 17, 2012

(51) Int. Cl. F16B 7/18

(52) U.S. Cl. CPC F16B 7/18
USPC 29/525.01; 403/187

(57) ABSTRACT

What is disclosed is an apparatus that provides connection points on a piping system to facilitate motion restraint using external motion-restraining systems. The apparatus is a type of plug (or cap) that engages into (or onto) a piping opening by threaded engagement, or by circumferentially grooved pipe coupling. The load-attachment connectors disclosed are particularly adapted for securing connection elements used with seismic sway brace and restraint between a fluid pipe line or pipe system and a fixed structure, to anchor that system or pipeline to the structure. The load-attachment connector has at least three alternatives available for the connection to useful external attachments: a flat tab (with bore hole); a tapped hole; and a threaded stud.

### BACKGROUND OF THE INVENTION

Sway braces and restraints are commonly used in building structures for securing numerous types of fluid-supply lines to the structure to brace or restrain the lines against damaging movement such as could occur in a seismic event. An example of a seismic sway brace is seen in U.S. Pat. No. 4,697,770 to Kirschner. The Kirschner sway brace secures a fluid supply line to a joist or other building structure by means of an elongated tubular bracing member that is held adjacent to one of its ends by the sway brace, and that is fastened at its other end to the joist by a pair of bolts or other approved fasteners.

Recent industry code changes have required additional installation of bracing and restraint of pipe systems in areas subject to seismic events or in structures that are vital to emergency response. Generally, all current forms of attaching sway brace and restraint to pipe and pipe systems have used various methods that to a greater or lesser extent involve squeezing the pipe or conduit. For some piping systems, such as steel or copper pipe, this is an acceptable method of securing a brace or restraint to the pipe. However, for other systems made of materials for which the manufacturer specifically prohibits the compression of the product for any reason, such as CPVC, due to the increased likelihood of stress fractures, these means of attachment are not acceptable. For these systems another type of attachment is necessary. What would be advantageous is for piping systems to have built-in attachment points/devices such that no compression of the pipe itself is necessary to facilitate the motion restraint of the piping system.

### BRIEF DESCRIPTION OF THE DRAWINGS

FIG. 1A depicts an embodiment of a male-threaded pipe-fitting-attachment device for supporting industrial piping, with a tab-type attachment interface adapted for coupling to an external motion-restraining device.

FIG. 1B depicts an embodiment of a male-threaded pipe-fitting-attachment device for supporting industrial piping, with a tapped-threaded-hole attachment interface adapted for coupling to an external motion-restraining device.

FIG. 1C depicts an embodiment of a male-threaded pipe-fitting-attachment device for supporting industrial piping, with a threaded-stud attachment interface adapted for coupling to an external motion-restraining device.

FIG. 2A depicts one embodiment of a male-threaded pipe-fitting-attachment device, with a tab-type attachment interface, for supporting industrial piping, installed in a female-threaded piping outlet coupling point at the end of a pipe.

FIG. 2B depicts one embodiment of a male-threaded pipe-fitting-attachment device, with a tab-type attachment interface, for supporting industrial piping, installed in a female-threaded piping outlet coupling point at the end of a pipe, with an external motion-restraining fixture attached via a fastener and the bore disposed in the tab-type attachment interface.

FIG. 3A depicts one embodiment of a male-threaded pipe-fitting-attachment device, with a tab-type attachment interface, for supporting industrial piping, installed in a female-threaded piping outlet coupling point disposed in the middle of a piping run.

FIG. 3B depicts one embodiment of a male-threaded pipe-fitting-attachment device, with a tab-type attachment interface, for supporting industrial piping, installed in a female-threaded piping outlet coupling point disposed in the middle of a piping run, with an external motion-restraining fixture attached via a fastener and the bore disposed in the tab-type attachment interface.

FIG. 4A depicts one embodiment of a male-threaded pipe-fitting-attachment device, with a tapped-threaded-hole attachment interface (with a bolt installed), for supporting industrial piping, installed in a female-threaded piping outlet coupling point at the end of a Pipe.

FIG. 4B depicts one embodiment of a male-threaded pipe-fitting-attachment device, with a tapped-threaded-hole attachment interface, for supporting industrial piping, installed in a female-threaded piping outlet coupling point at the end of a pipe, with an external motion-restraining fixture attached with a bolt.

FIG. 5A depicts one embodiment of a male-threaded pipe-fitting-attachment device, with a tapped-threaded-hole attachment interface, for supporting industrial piping, installed in a female-threaded piping outlet coupling point disposed in the middle of a piping run.

FIG. 5B depicts one embodiment of a male-threaded pipe-fitting-attachment device, with a tapped-threaded-hole attachment interface, for supporting industrial piping, installed in a female-threaded piping outlet coupling point disposed in the middle of a piping run, with an external motion-restraining fixture attached with a bolt.

FIG. 6A depicts one embodiment of a male-threaded pipe-fitting-attachment device, with a threaded-stud attachment interface, for supporting industrial piping, installed in a female-threaded piping outlet coupling point at the end of a pipe.

FIG. 6B depicts one embodiment of a male-threaded pipe-fitting-attachment device, with a threaded-stud attachment interface, for supporting industrial piping, installed in a female-threaded piping outlet coupling point at the end of a pipe, with an external motion-restraining fixture attached over the stud with a nut.

FIG. 7A depicts one embodiment of a male-threaded pipe-fitting-attachment device, with a threaded-stud attachment interface, for supporting industrial piping, installed in a female-threaded piping outlet coupling point disposed in the middle of a piping run.

FIG. 7B depicts one embodiment of a male-threaded pipe-fitting-attachment device, with a threaded-stud attachment interface, for supporting industrial piping, installed in a female-threaded piping outlet coupling point disposed in the middle of a piping run, with an external motion-restraining fixture attached over the stud with a nut.

FIG. 8A depicts an embodiment of a female-threaded pipe-fitting-attachment device for supporting industrial piping, with a tab-type attachment interface adapted for coupling to an external motion-restraining device.

FIG. 8B depicts an embodiment of a female-threaded pipe-fitting-attachment device for supporting industrial piping, with a tapped-threaded-hole attachment interface adapted for coupling to an external motion-restraining device.

FIG. 8C depicts an embodiment of a female-threaded pipe-fitting-attachment device for supporting industrial piping, with a threaded-stud attachment interface adapted for coupling to an external motion-restraining device.

FIG. 9A depicts one embodiment of a female-threaded pipe-fitting-attachment device, with a tab-type attachment interface, for supporting industrial piping, installed in a male-threaded piping outlet coupling point at the end of a pipe.

FIG. 9B depicts one embodiment of a female-threaded pipe-fitting-attachment device, with a tab-type attachment interface, for supporting industrial piping, installed in a male-threaded piping outlet coupling point at the end of a pipe, with an external motion-restraining fixture attached via a fastener and the bore disposed in the tab-type attachment interface.

FIG. 10A depicts one embodiment of a female-threaded pipe-fitting-attachment device, with a tab-type attachment interface, for supporting industrial piping, installed in a male-threaded piping outlet coupling point disposed in the middle of a piping run.

FIG. 10B depicts one embodiment of a female-threaded pipe-fitting-attachment device, with a tab-type attachment interface, for supporting industrial piping, installed in a male-threaded piping outlet coupling point disposed in the middle of a piping run, with an external motion-restraining fixture attached via a fastener and the bore disposed in the tab-type attachment interface.

FIG. 11A depicts one embodiment of a female-threaded pipe-fitting-attachment device, with a tapped-threaded-hole attachment interface (with a bolt installed), for supporting industrial piping, installed in a male-threaded piping outlet coupling point at the end of a pipe.

FIG. 11B depicts one embodiment of a female-threaded pipe-fitting-attachment device, with a tapped-threaded-hole attachment interface, for supporting industrial piping, installed in a male-threaded piping outlet coupling point at the end of a pipe, with an external motion-restraining fixture attached with a bolt.

FIG. 12A depicts one embodiment of a female-threaded pipe-fitting-attachment device, with a tapped-threaded-hole attachment interface, for supporting industrial piping, installed in a male-threaded piping outlet coupling point disposed in the middle of a piping run.

FIG. 12B depicts one embodiment of a female-threaded pipe-fitting-attachment device, with a tapped-threaded-hole attachment interface, for supporting industrial piping, installed in a male-threaded piping outlet coupling point disposed in the middle of a piping run, with an external motion-restraining fixture attached with a bolt.

FIG. 13A depicts one embodiment of a female-threaded pipe-fitting-attachment device, with a threaded-stud attachment interface, for supporting industrial piping, installed in a male-threaded piping outlet coupling point at the end of a pipe.

FIG. 13B depicts one embodiment of a female-threaded pipe-fitting-attachment device, with a threaded-stud attachment interface, for supporting industrial piping, installed in a male-threaded piping outlet coupling point at the end of a pipe, with an external motion-restraining fixture attached over the stud with a nut.

FIG. 14A depicts one embodiment of a female-threaded pipe-fitting-attachment device with a threaded-stud attachment interface, for supporting industrial piping, installed in a male-threaded piping outlet coupling point disposed in the middle of a piping run.

FIG. 14B depicts one embodiment of a female-threaded pipe-fitting-attachment device, with a threaded-stud attachment interface, for supporting industrial piping, installed in a male-threaded piping outlet coupling point disposed in the middle of a piping run, with an external motion-restraining fixture attached over the stud with a nut.

FIG. 15A depicts an embodiment of a circumferentially grooved pipe-fitting-attachment device for supporting industrial piping, with a tab-type attachment interface adapted for coupling to an external motion-restraining device.

FIG. 15B depicts an embodiment of a circumferentially grooved pipe-fitting-attachment device for supporting industrial piping, with a tapped-threaded-hole attachment interface adapted for coupling to an external motion-restraining device.

FIG. 15C depicts an embodiment of a circumferentially grooved pipe-fitting-attachment device for supporting industrial piping, with a threaded-stud attachment interface adapted for coupling to an external motion-restraining device.

FIG. 16A depicts one embodiment of a circumferentially grooved pipe-fitting-attachment device, with a tab-type attachment interface, for supporting industrial piping, installed in a circumferentially grooved piping outlet coupling point at the end of a pipe, using a grooved-pipe-coupler device that engages the grooves on both the pipe and the pipe-fitting-attachment device.

FIG. 16B depicts one embodiment of a circumferentially grooved pipe-fitting-attachment device, with a tab-type attachment interface, for supporting industrial piping, installed in a circumferentially grooved piping outlet coupling point at the end of a pipe, using a grooved-pipe-coupler device that engages the grooves on both the pipe and the pipe-fitting-attachment device, with an external motion-restraining fixture attached via a fastener and the bore disposed in the tab-type attachment interface.

FIG. 17A depicts one embodiment of a circumferentially grooved pipe-fitting-attachment device, with a tab-type attachment interface, for supporting industrial piping, installed in a circumferentially grooved piping outlet coupling point disposed in the middle of a piping run, using a grooved-pipe-coupler device that engages the grooves on both the pipe and the pipe-fitting-attachment device.

FIG. 17B depicts one embodiment of a circumferentially grooved pipe-fitting-attachment device, with a tab-type attachment interface, for supporting industrial piping, installed in a circumferentially grooved piping outlet coupling point disposed in the middle of a piping run, using a grooved-pipe-coupler device that engages the grooves on both the pipe and the pipe-fitting-attachment device, with an external motion-restraining fixture attached via a fastener and the bore disposed in the tab-type attachment interface.

FIG. 18A depicts one embodiment of a circumferentially grooved pipe-fitting-attachment device, with a tapped-threaded-hole attachment interface (with a bolt installed), for supporting industrial piping, installed in a circumferentially grooved piping outlet coupling point at the end of a pipe, using a grooved-pipe-coupler device that engages the grooves on both the pipe and the pipe-fitting-attachment device.

FIG. 18B depicts one embodiment of a circumferentially grooved pipe-fitting-attachment device, with a tapped-threaded-hole attachment interface, for supporting industrial piping, installed in a circumferentially grooved piping outlet coupling point at the end of a pipe, using a grooved-pipe-coupler device that engages the grooves on both the pipe and the pipe-fitting-attachment device, with an external motion-restraining fixture attached with a bolt.

FIG. 19A depicts one embodiment of a circumferentially grooved pipe-fitting-attachment device, with a tapped-threaded-hole attachment interface, for supporting industrial piping, installed in a circumferentially grooved piping outlet coupling point disposed in the middle of a piping run, using a grooved-pipe-coupler device that engages the grooves on both the pipe and the pipe-fitting-attachment device.

FIG. 19B depicts one embodiment of a circumferentially grooved pipe-fitting-attachment device, with a tapped-threaded-hole attachment interface, for supporting industrial piping installed in a circumferentially grooved piping outlet coupling point disposed in the middle of a piping run, using a grooved-pipe-coupler device that engages the grooves on both the pipe and the pipe-fitting-attachment device, with an external motion-restraining fixture attached with a bolt.

FIG. 20A depicts one embodiment of a circumferentially grooved pipe-fitting-attachment device, with a threaded-stud attachment interface, for supporting industrial piping, installed in a circumferentially grooved piping outlet coupling point at the end of a pipe, using a grooved-pipe-coupler device that engages the grooves on both the pipe and the pipe-fitting-attachment device.

FIG. 20B depicts one embodiment of a circumferentially grooved pipe-fitting-attachment device, with a threaded-stud attachment interface, for supporting industrial piping, installed in a circumferentially grooved piping outlet coupling point at the end of a pipe, using a grooved-pipe-coupler device that engages the grooves on both the pipe and the pipe-fitting-attachment device, with an external motion-restraining fixture attached over the stud with a nut.

FIG. 21A depicts one embodiment of a circumferentially grooved pipe-fitting-attachment device, with a threaded-stud attachment interface, for supporting industrial piping, installed in a circumferentially grooved piping outlet coupling point disposed in the middle of a piping run, using a grooved-pipe-coupler device that engages the grooves on both the pipe and the pipe-fitting-attachment device.

FIG. 21B depicts one embodiment of a circumferentially grooved pipe-fitting-attachment device, with a threaded-stud attachment interface, for supporting industrial piping, installed in a circumferentially grooved piping outlet coupling point disposed in the middle of a piping run, using a grooved-pipe-coupler device that engages the grooves on both the pipe and the pipe-fitting-attachment device, with an external motion-restraining fixture attached over the stud with a nut.

FIG. 22 depicts one embodiment of a piping system with a plurality of motion restraints coupled to it by way of a plurality of various pipe-fitting-attachment devices coupled to piping outlet points, wherein each of the pipe-fitting-attachment devices can be any of the pipe-fitting-attachment devices described within this disclosure so long as the piping outlet coupling point can support the type of pipe-fitting-attachment device (i.e., male threads, females threads, or circumferential grooving), and the intended external motion-restraint device can support the type of external-attachment interface (i.e., tab-type, tapped-threaded hole, or threaded stud).

### DETAILED DESCRIPTION

### Overview

The present inventive disclosure is directed generally to an apparatus that provides connection points on a piping system to facilitate motion restraint using external motion-restraining systems. The design is useful in both restraint and bracing of lateral or longitudinal seismic loads. These are the primary types of loads which are code required to be restrained or braced.

By using a piping outlet that is circumferentially grooved, or alternatively has male or female threading, hereafter collectively referred to as a pipe-outlet attachment interface, wherein the piping outlet attachment interface is either added to, or already exists in, a piping system and then attaching an external motion-restraining device to that outlet, undesired compression of the piping components can be avoided. While this type of motion restraint offers specific advantages for piping systems which are not able to resist compression type braces, it is also suitable for use with all pipe systems where a pipe-outlet attachment interface is or can be installed. Pipe-outlet attachment interfaces can be installed at appropriate intervals to allow for the reduction of the seismic loads between multiple points. These multiple connection points can restrain or brace the piping system from both lateral and longitudinal loads in a seismic event.

The present inventive disclosure relates to a load-attachment connector, particularly adapted for securing connection elements used with seismic sway brace and restraint between a fluid pipe line or pipe system and a fixed structure, to anchor that system or pipeline to the structure. The general goal is to provide a secure attachment point to pipe fittings and pipe systems without any compression-type loads.

The load-attachment connector has at least three alternatives available for the connection to seismic brace or restraint elements or other useful attachments. These three attachment-point types are: (1) A flat tab of appropriate size and thickness, usually comprised of metal, projecting from the exposed end of the threaded portion of the connector, with a hole, of appropriate size, in it to connect to a number of different types of brace and restraint connections; (2) A tapped hole substantially centered in the exposed end of the threaded connector, tapped with threads compatible with a machine bolt which will thread into the connection securing some brace or restraint component; and (3) A stud substantially centered in the exposed end of the threaded connection threaded with a machine thread compatible with a nut used to secure the connection of some brace or restraint component. Larger and thicker tabs with larger holes, as well as larger tapped holes or studs, can be used to attach larger loads compatible with increased strength requirements to meet different seismic codes. The varied ways of attaching to the threaded connector allow a wide range of types of seismic braces and/or restraint attachments to be connected to a piping system.

While this solution is optimal for applications involving the seismic bracing and restraint for piping systems, the devices disclosed herein may also offer a suitable attachment point in other applications, all of which is intended to be encompassed within the scope of this disclosure, including the patent claims that follow.

The present invention is intended to provide the primary point of attachment for seismic braces and restraints to pipe systems, in areas requiring seismic design.

### Terminology

The terms and phrases as indicated in quotes (“ ”) in this section are intended to have the meaning ascribed to them in this Terminology section applied to them throughout this document, including the claims, unless clearly indicated otherwise in context. Further, as applicable, the stated definitions are to apply, regardless of the word or phrase's case, to the singular and plural variations of the defined word or phrase.

The term “or”, as used in this specification and the appended claims, is not meant to be exclusive; rather, the term is inclusive, meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of the phrase “in one embodiment” and/or “in one variation” in various places in the specification are not necessarily all meant to refer to the same embodiment.

The term “couple” or “coupled”, as used in this specification and the appended claims, refers to either an indirect or a direct connection between the identified elements, components, or objects. Often the manner of the coupling will be related specifically to the manner in which the two coupled elements interact.

The term “removable”, “removably coupled”, “readily removable”, “readily detachable”, and similar terms, as used in this patent application specification (including the claims and drawings), refer to structures that can be uncoupled from an adjoining structure with relative ease (i.e., non-destructively and without a complicated or time-consuming process) and that can also be readily reattached or coupled to the previously adjoining structure.

Directional and/or relational terms such as, but not limited to, left, right, nadir, apex, top, bottom, vertical, horizontal, back, front, and lateral are relative to each other, are dependent on the specific orientation of an applicable element or article, are used accordingly to aid in the description of the various embodiments, and are not necessarily intended to be construed as limiting.

As applicable, the terms “about” or “generally”, as used herein unless otherwise indicated, means a margin of +−20%. Also, as applicable, the term “substantially” as used herein unless otherwise indicated means a margin of +−10%. It is to be appreciated that not all uses of the above terms are quantifiable such that the referenced ranges can be applied.

The terms “pipe-fitting-attachment device” or “piping-support apparatus”, as used in this specification and the appended claims, refer to either a plug or a cap device that is sealingly installed at the end of a pipe outlet/fitting. Typically, such devices can be a male-threaded plug, a female-threaded cap, or a circumferentially grooved plug (though some manufacturers consider a circumferentially grooved pipe-fitting termination as a cap instead of a plug). The terms “pipe-fitting-attachment device” and “piping-support apparatus” are each intended to be a convenient general term to encompass either a plug-type or cap-type pipe-fitting termination. Specific differences between the various types of pipe-fitting terminations are described herein as necessary to properly describe the applications in different embodiments.

### First Embodiment

### A Male-Threaded Pipe-Fitting-Attachment Device for Supporting Industrial Piping

This embodiment is directed generally to a threaded plug-type apparatus adapted to be coupled to an outlet point in a piping system.

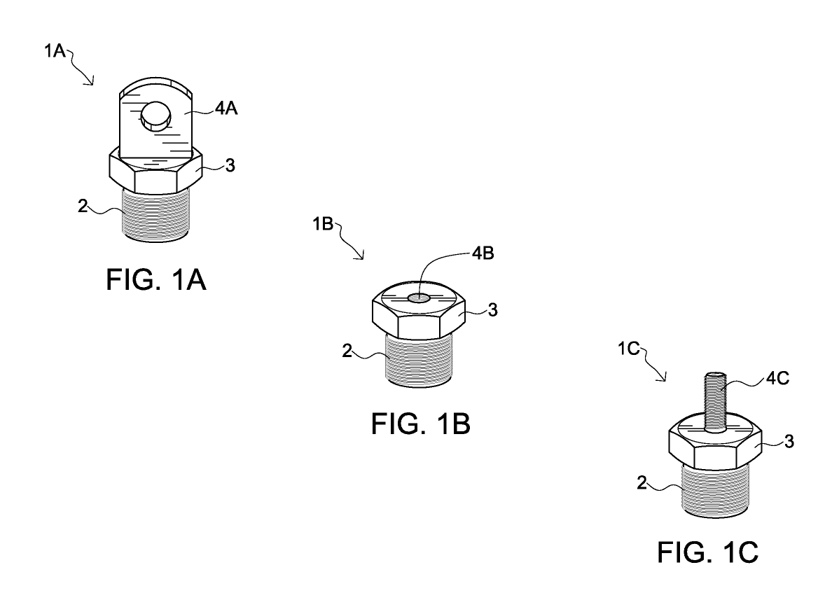

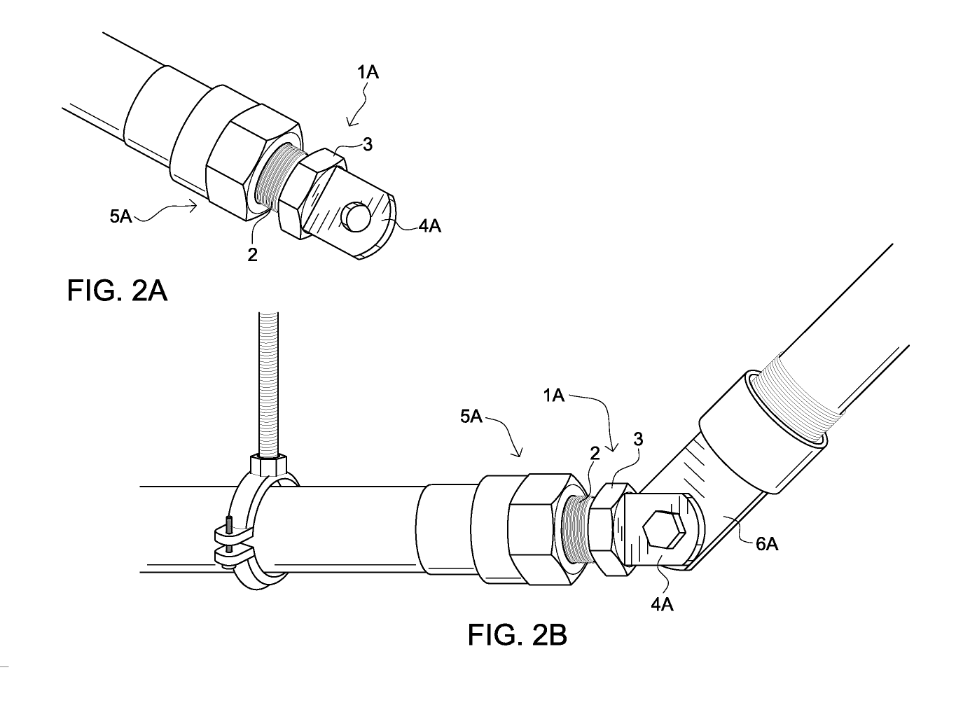

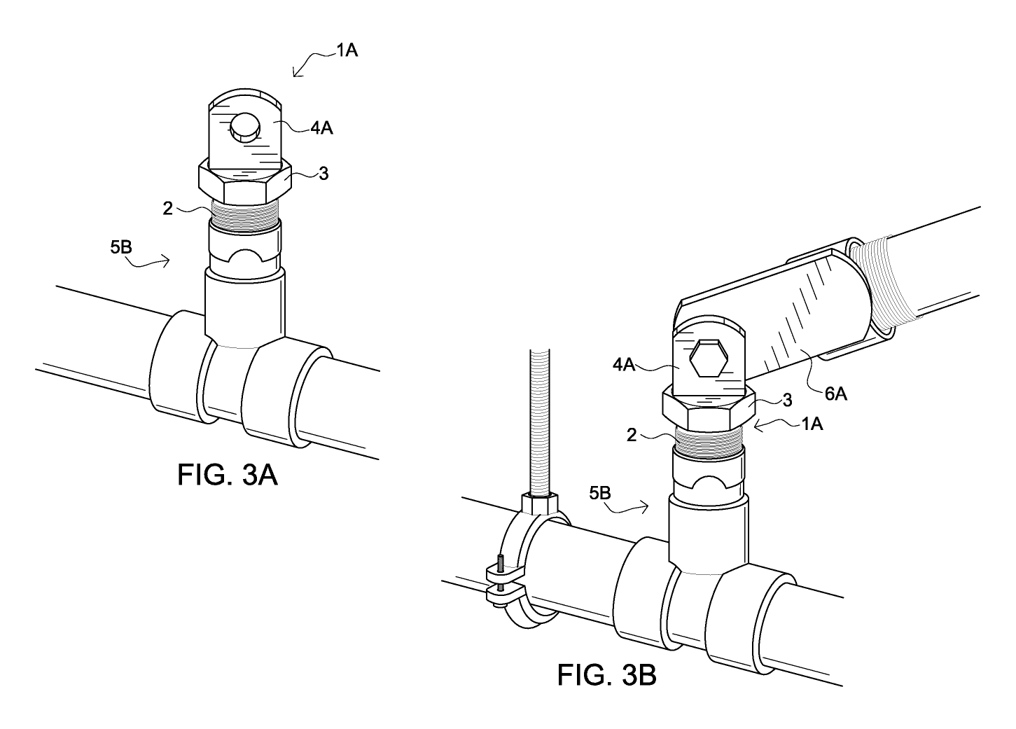

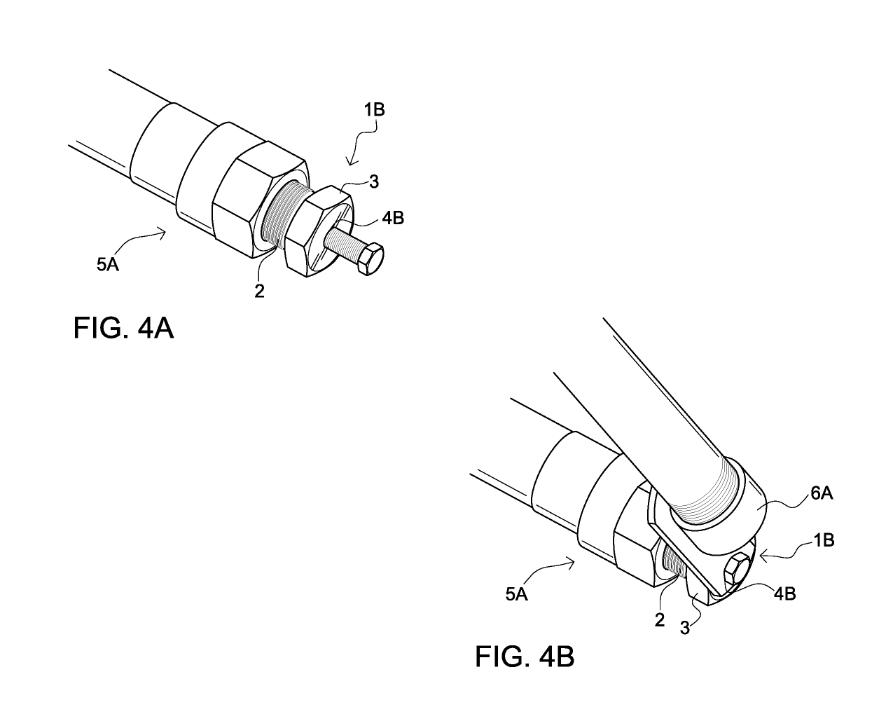

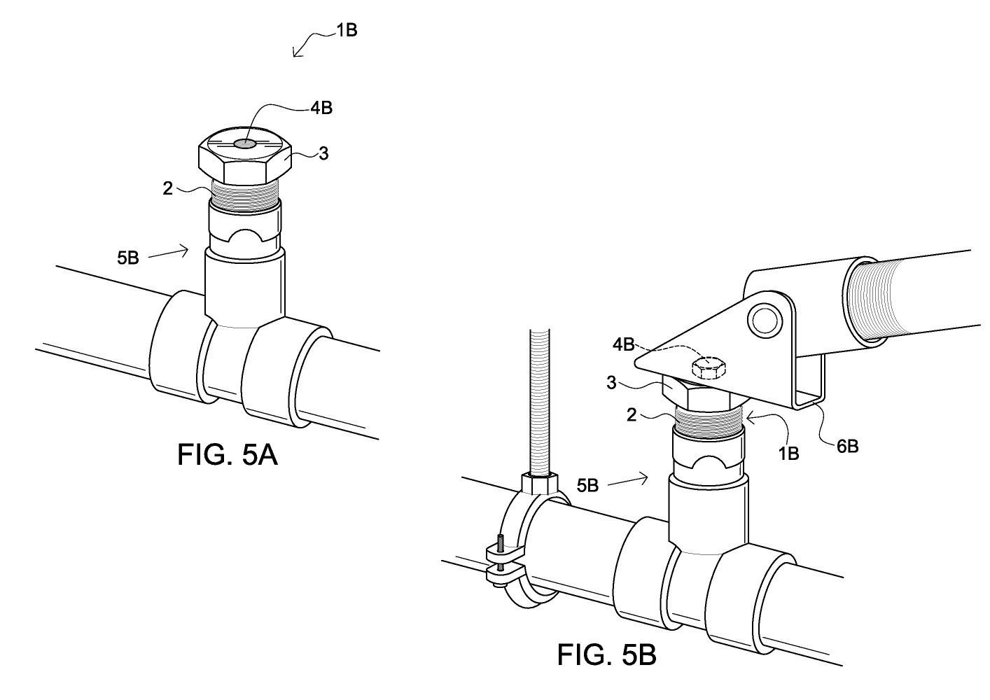

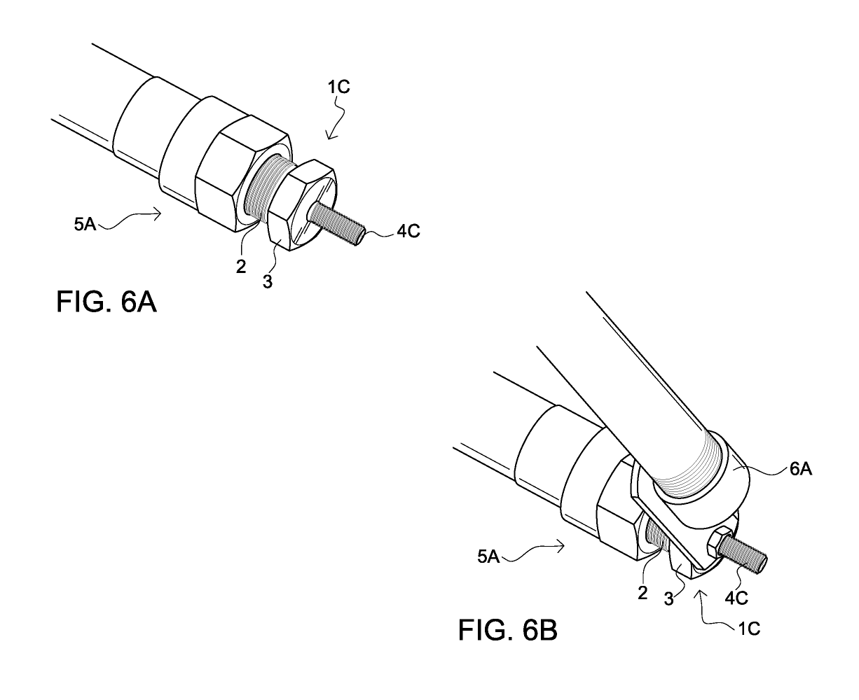

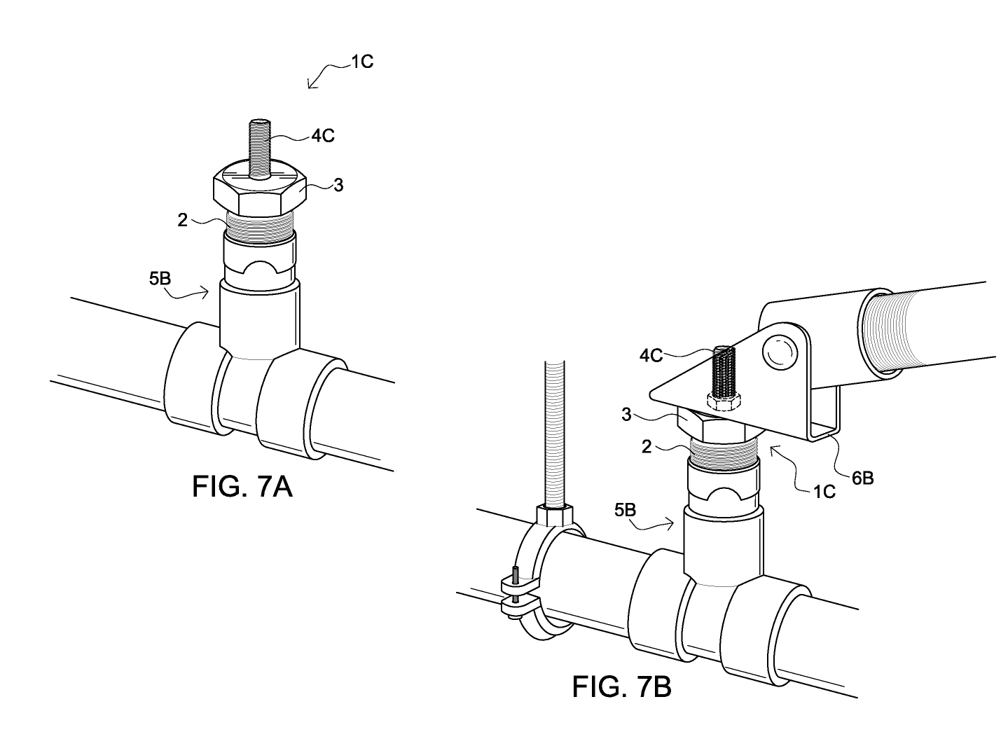

Refer to FIGS. 1A-7B. In this embodiment, the apparatus is comprised of a male thread 2 formed on a solid plug 1A, 1B, 1C. The standard for the plug threads 2 can be National Pipe Thread, metric standard thread, or a system-specific thread. The thread 2 is designed to screw into, and seal into, a female piping outlet or fitting 5A, 5B. In a typical embodiment, the plug 1A, 1B, 1C is sized and adapted to be installed into the female-threaded piping outlet/fitting 5A, 5B using compatible pipe dope or thread sealant, commonly known and available in the art, and is then tightened using normal pipe wrenches or other appropriate tools. In other variations, the plug 1A, 1B, 1C is self-sealing when installed.

In an embodiment, the plug member 1A, 1B, 1C extends beyond the thread-engagement portion 2 in a geometric shape 3 that serves as a gripping section 3, which can be used to tighten or loosen the threaded coupling with the piping outlet or fitting 5A, 5B. In many embodiments, this geometrically-shaped gripping section 3 can be round, square, hexagonal, pentagonal, or any other shape which will allow a tool to tighten and/or loosen the plug member 1A, 1B, 1C into the piping outlet or fitting 5A, 5B.

In still other embodiments, the apparatus 1A, 1B, 1C has a means 4A, 4B, 4C to attach and fasten an external motion-restraining device 6A, 6B to the plug member 1A, 1B, 1C. In some embodiments, the external motion-restraining device 6A, 6B can be a seismic brace or restraint (e.g., a mechanical, hydraulic, or pneumatic snubber, a sway brace, etc.), which, when attached to the plug member 1A, 1B, 1C, inhibits or prevents undesired movement of the associated piping system.

In a variation of this embodiment, the attachment means 4A, 4B, 4C between the plug member 1A, 1B, 1C and the external motion-restraining device 6A, 6B is a tab or “ear” 4A that can be welded to, machined from, or formed as part of the plug member 1A. Preferably, this tab or ear 4A is configured to be substantially perpendicular to the exposed end 3 of the plug element 1A and substantially centered on the plug member 1A. The tab or ear 4A should be of sufficient size and thickness to provide for the applied seismic loads it will expect to see based upon the size of the threaded plug member 1A. The tab or ear 4A should have a drilled, bored, or formed hole disposed substantially in the center of the tab or ear 4A with the size of the hole corresponding to the applied seismic load, and the expected size of the fastener (such as, e.g., a through-bolt) to be used to connect the external brace or motion restraint 6A, 6B to the tab or ear 4A.

In another variation of this embodiment, the attachment means 4A, 4B, 4C between the plug member 1A, 1B, 1C and the external motion-restraining device 6A, 6B is a tapped hole 4B into the exposed end of the solid plug member 1B, using a compatible thread such that a threaded fastener, such as a bolt, may be screwed into the plug member 1B in order to attach and secure an external seismic brace or restraint 6A, 6B. The size of the tapped bolt hole 4B should correspond to the size of the plug member 1B and the expected applied seismic load or the required threaded fastener size for the external brace or restraint element 6A, 6B to be attached. In some embodiments, this tapped hole 4B can be drilled and tapped, machined, or formed/cast into the plug member 1B.

In yet another variation of this embodiment, the attachment means 4A, 4B, 4C between the plug member 1A, 1B, 1C and the external motion-restraining device 6A, 6B is a threaded stud 4C substantially centered into the exposed end of the plug member 1C. The size and thread type should correspond to the expected applied seismic loads, to the corresponding size of the plug member 1C, and to the required bolt size for the brace or restraint element 6A, 6B to be attached to the plug member 1C. The thread of the stud 4C should extend from the plug 1C sufficiently to allow the brace or restraint device 6A, 6B to be attached using any compatible and appropriately sized nut.

The alternatives offered by the device 1A, 1B, 1C allow many and varied manufacturers' products to be attached without modification. These products can be used for their intended purpose and attached to the pipe, piping system, fitting, or outlet 5a, 5B in a quick, affordable manner using standard or readily available hardware.

### Second Embodiment

### A Female-Threaded Pipe-Fitting-Attachment Device for Supporting Industrial Piping

This embodiment is directed generally to a threaded cap-type apparatus adapted to be coupled to an outlet point in a piping system.

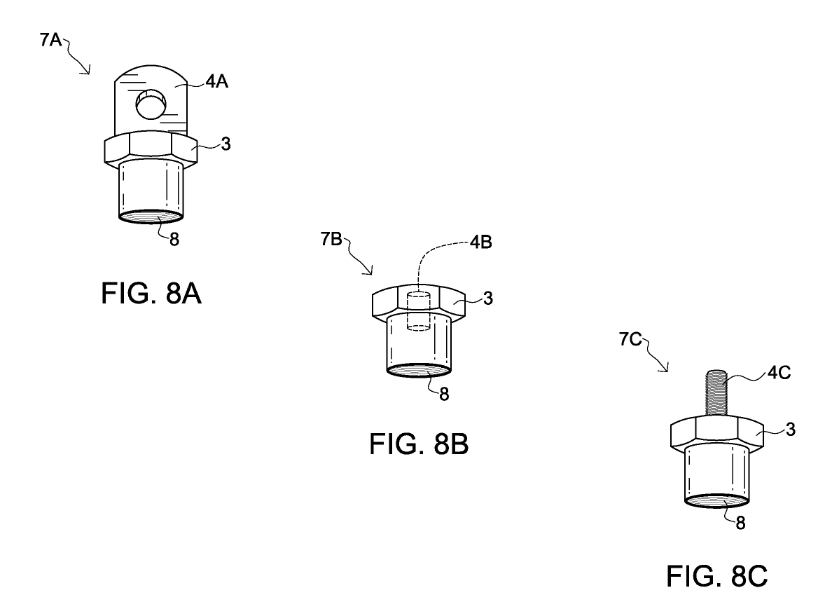

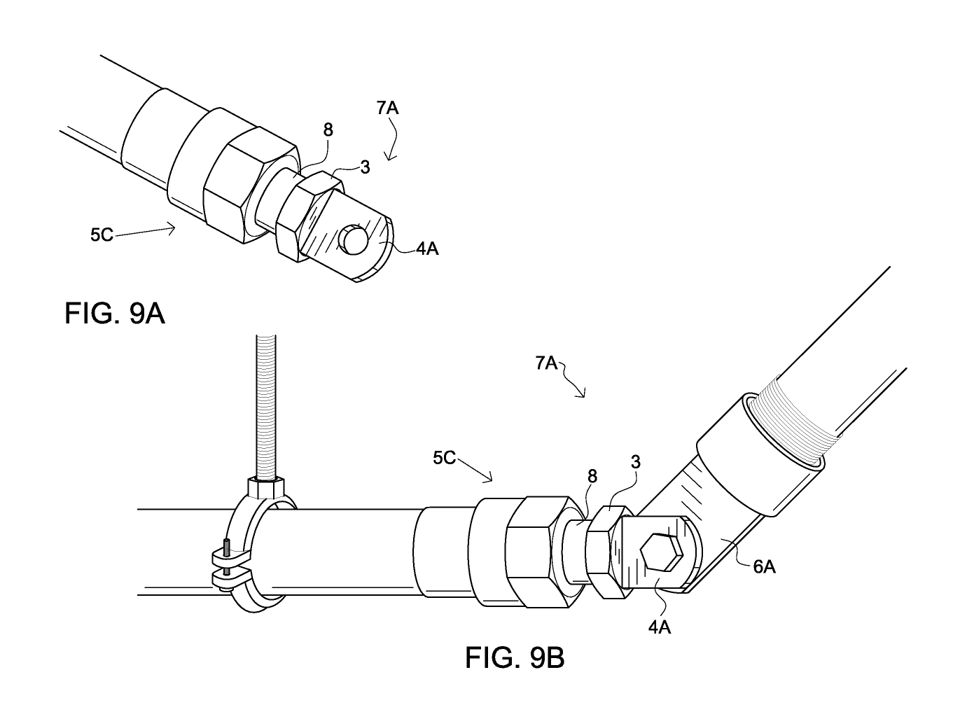

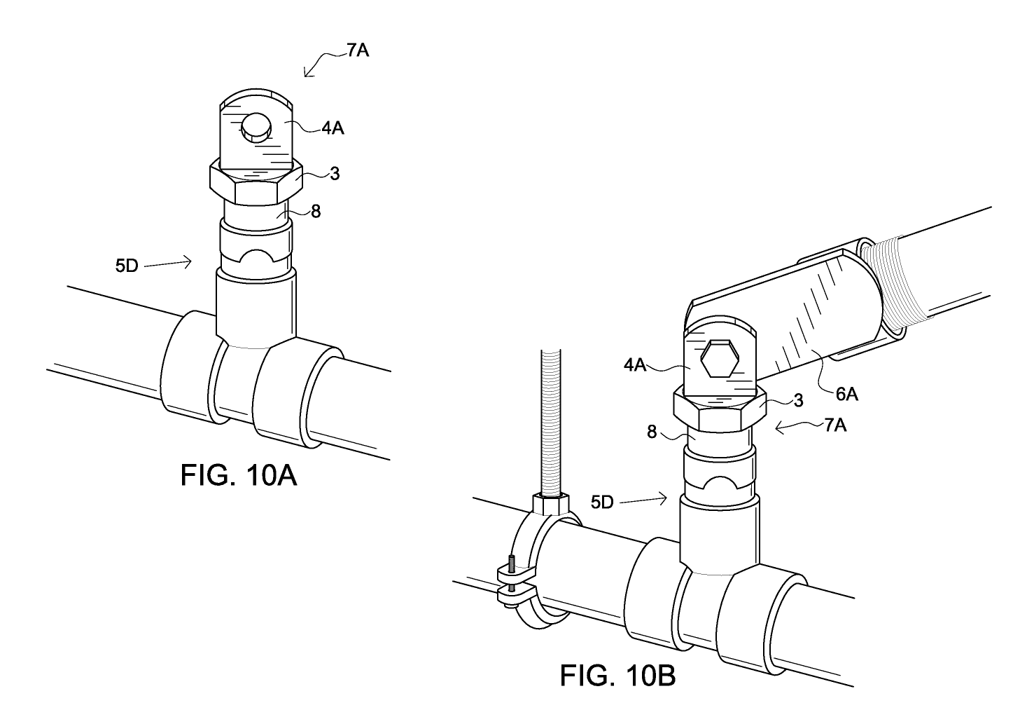

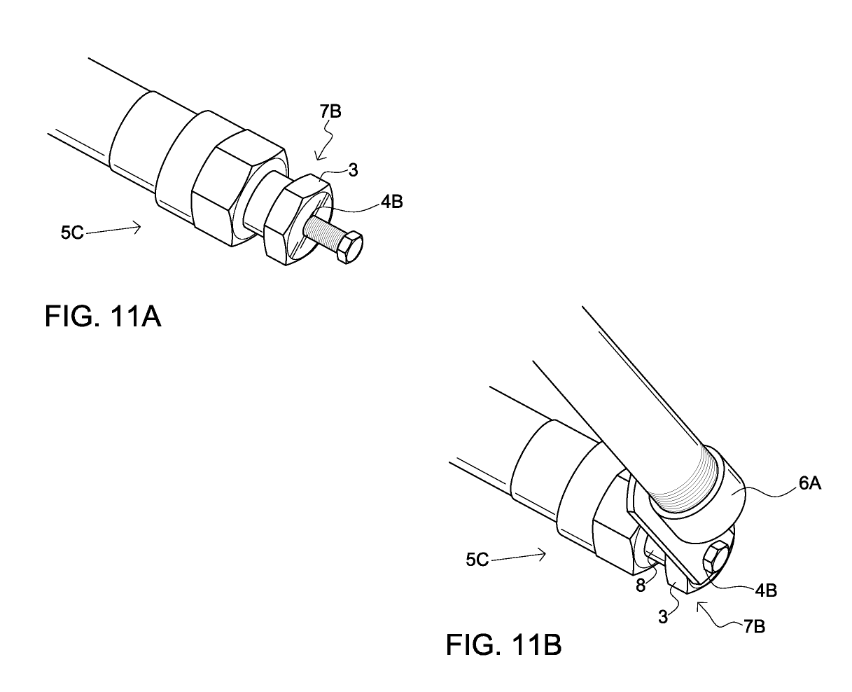

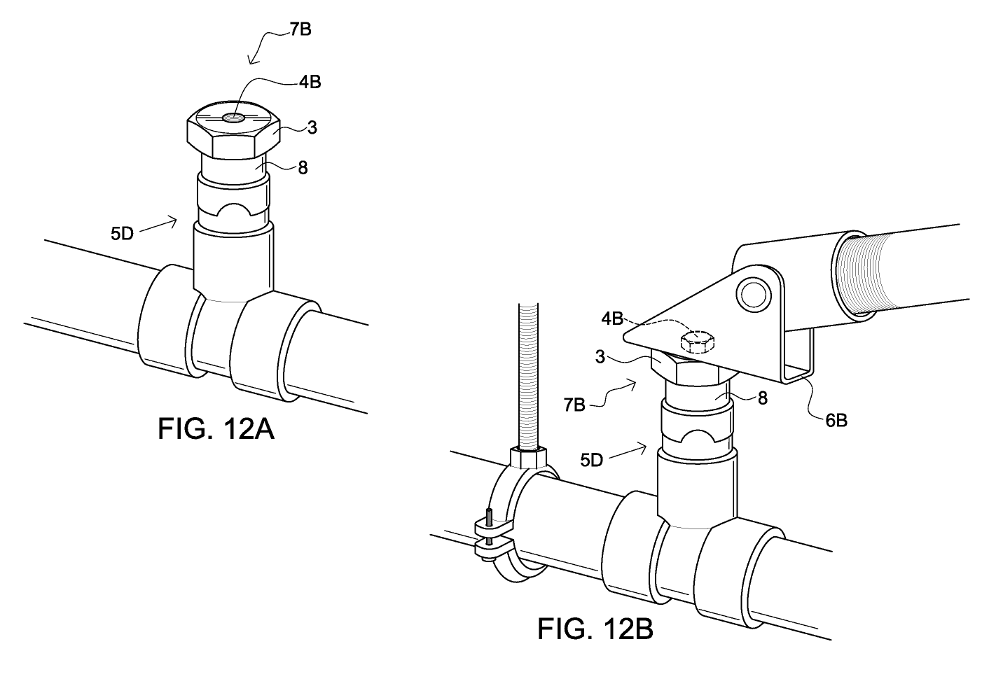

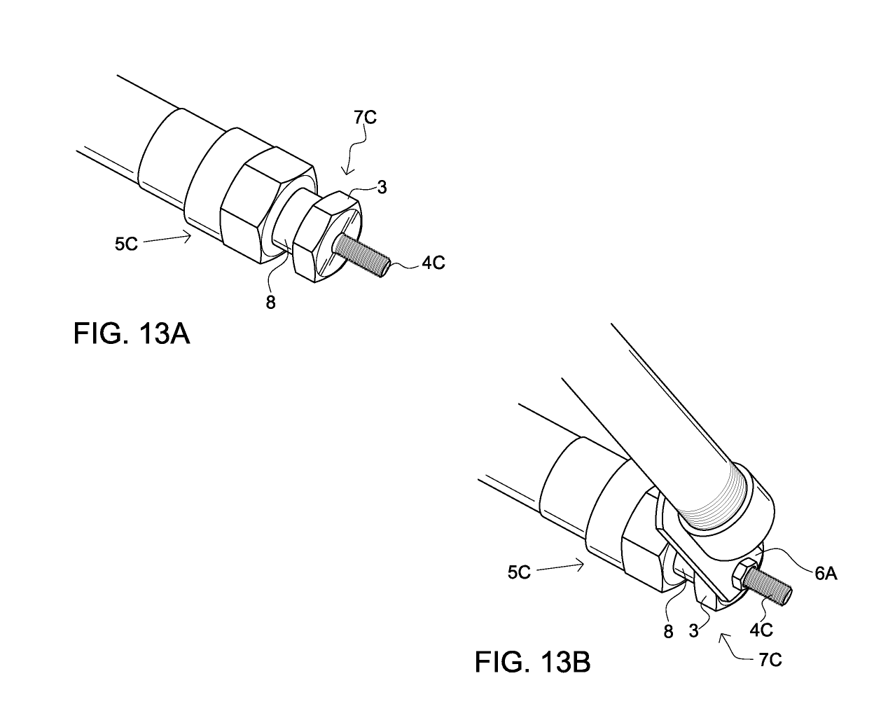

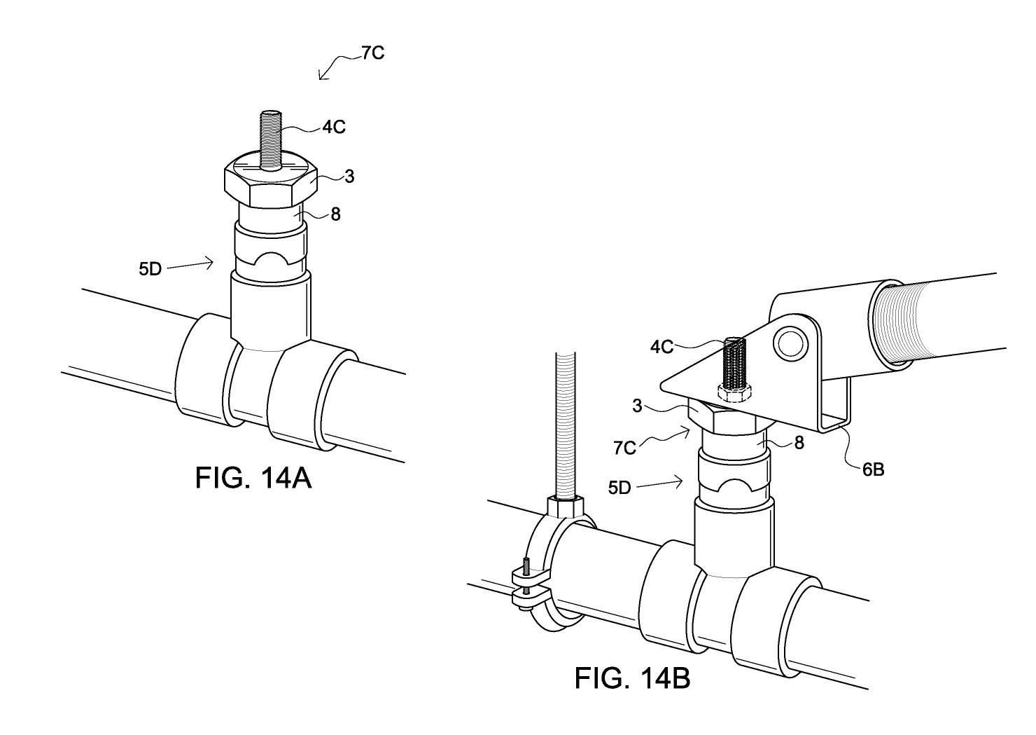

Refer to FIGS. 8A-14B. In this embodiment, the apparatus 7A, 7B, 7C is comprised of a cap element which has a hollowed lower region with female threads 8 disposed around the interior circumference. The standard for the cap threads 8 can be National Pipe Thread, metric standard thread, or a system-specific thread. The thread 8 is designed to screw onto, and seal onto, a male piping outlet or fitting 5C, 5D. In a typical embodiment, the cap 7A, 7B, 7C is sized and adapted to be installed onto the male piping outlet/fitting 5C, 5D using compatible pipe dope or thread sealant, commonly known and available in the art, and is then tightened using normal pipe wrenches or other appropriate tools. In other variations, the cap 7A, 7B, 7C is self-sealing when installed.

In an embodiment, the cap member 7A, 7B, 7C extends beyond the thread-engagement portion 8 in a geometric shape 3 that serves as a gripping section 3, which can be used to tighten or loosen the threaded coupling with the piping outlet or fitting 5C, 5D. In many embodiments, this geometrically-shaped gripping section 3 can be round, square, hexagonal, pentagonal, or any other shape which will allow a tool to tighten and/or loosen the cap member 7A, 7B, 7C into the piping outlet or fitting 5C, 5D.

In still other embodiments, the apparatus 7A, 7B, 7C has a means 4A, 4B, 4C to attach and fasten an external motion-restraining device 6A, 6B to the cap member 7A, 7B, 7C. In some embodiments, the external motion-restraining device 6A, 6B can be a seismic brace or restraint (e.g., a mechanical, hydraulic, or pneumatic snubber, a sway brace, etc.), which, when attached to the cap member 7A, 7B, 7C, inhibits or prevents undesired movement of the associated piping system.

In a variation of this embodiment, the attachment means 4A, 4B, 4C between the cap member 7A, 7B, 7C and the external motion-restraining device 6A, 6B is a tab or “ear” 4A that can be welded to, machined from, or formed as part of the cap member 7A, 7B, 7C. Preferably, this tab or ear 4A is configured to be substantially perpendicular to the exposed end of the cap element 7A and substantially centered on the cap member 7A. The tab or ear 4A should be of sufficient size and thickness to provide for the applied seismic loads it will expect to see based upon the size of the threaded cap member 7A. The tab or ear 4A will have a drilled, bored, or formed hole disposed substantially in the center of the tab or ear 4A with the size of the hole corresponding to the applied seismic load, and the expected size of the fastener (such as, e.g., a through-bolt) to be used to connect the external brace or motion restraint 6A, 6B to the tab or ear 7A.

In another variation of this embodiment, the attachment means between the cap member 7A, 7B, 7C and the external motion-restraining device 6A, 6B is a tapped hole 4B into the exposed end of the solid portion of the cap member 7B, using a compatible thread 8 such that a threaded fastener, such as a bolt, may be screwed into the cap member 7B in order to attach and secure an external seismic brace or restraint 6A, 6B. The size and thread type of the tapped bolt hole 4B should correspond to the size of the cap member 7B and the expected applied seismic load or the required threaded fastener size for the external brace or restraint element 6A, 6B to be attached. In some embodiments, this tapped hole 4B can be drilled and tapped, machined, or formed/cast into the cap member 7B.

In yet another variation of this embodiment, the attachment means between the cap member 7A, 7B, 7C and the external motion-restraining device 6A, 6B is a threaded stud 4C substantially centered into the exposed end of the cap member 7C. The size and thread type should correspond to the expected applied seismic loads, to the corresponding size of the cap member 7C, and to the required stud size for the brace or restraint element 6A, 6B to be attached to the cap member 7C. The thread of the stud 4C should extend from the cap 7C sufficiently to allow the brace or restraint device 6A, 6B to be attached using any compatible and appropriately sized nut.

The alternatives offered by the device 7A, 7B, 7C allow many and varied manufacturers' products to be attached without modification. These products can be used for their intended purpose and attached to the pipe, piping system, fitting, or outlet 5C, 5D in a quick, affordable manner using standard or readily available hardware.

### Third Embodiment

### A Circumferentially Grooved Pipe-Fitting-Attachment Device for Supporting Industrial Piping

This embodiment is directed generally to a circumferentially grooved plug-type apparatus adapted to be coupled to an outlet point in a piping system.

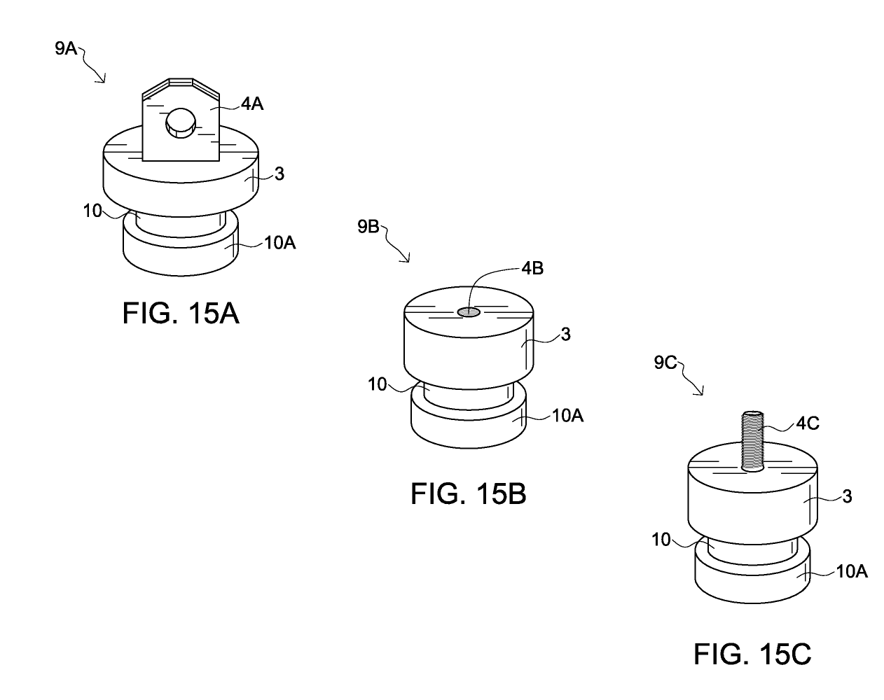

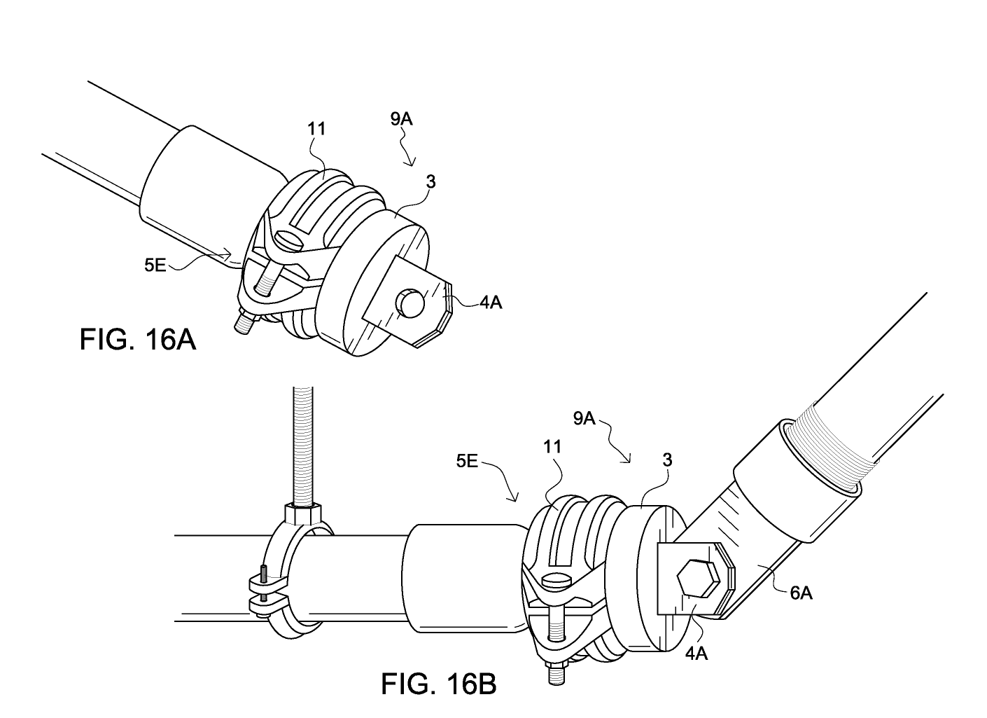

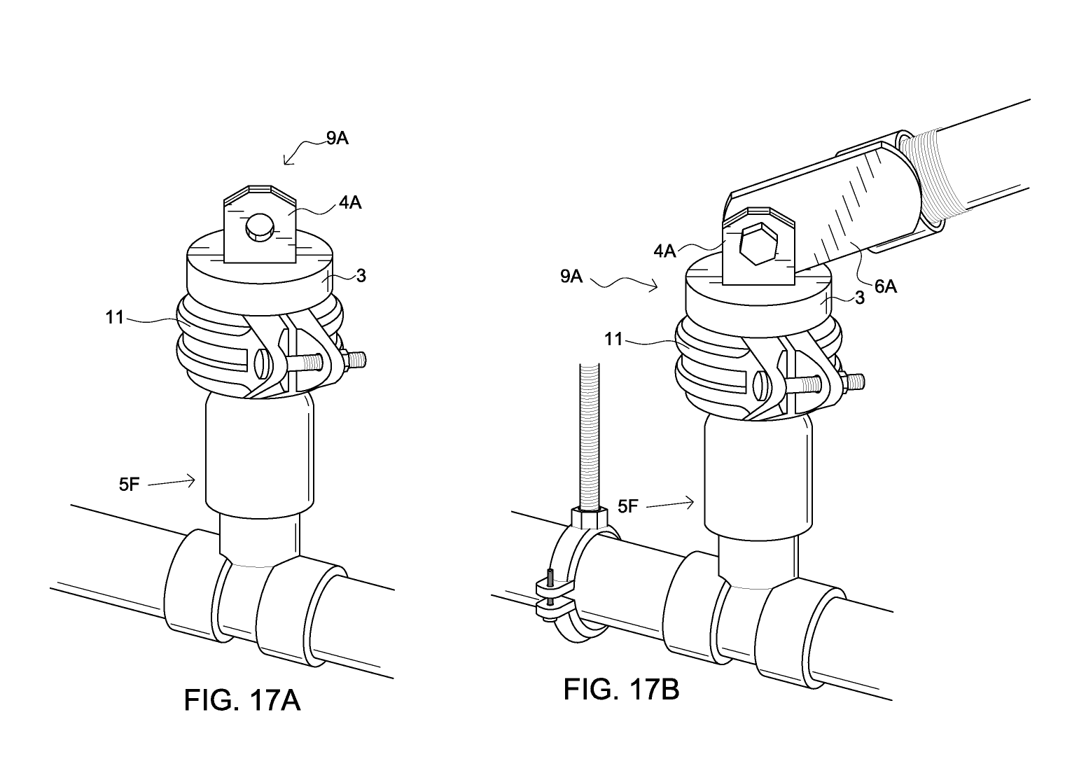

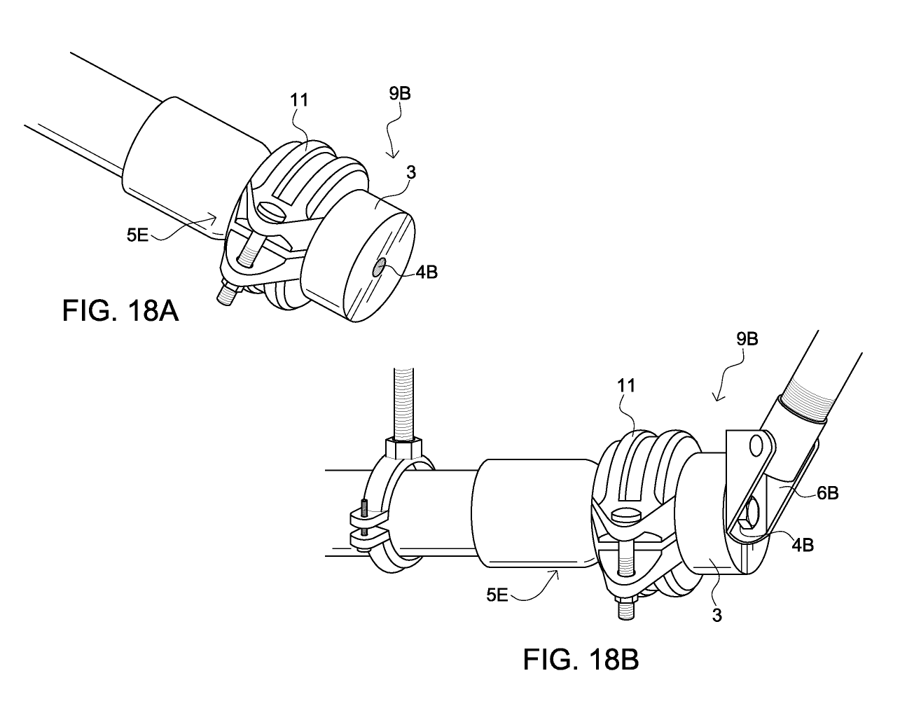

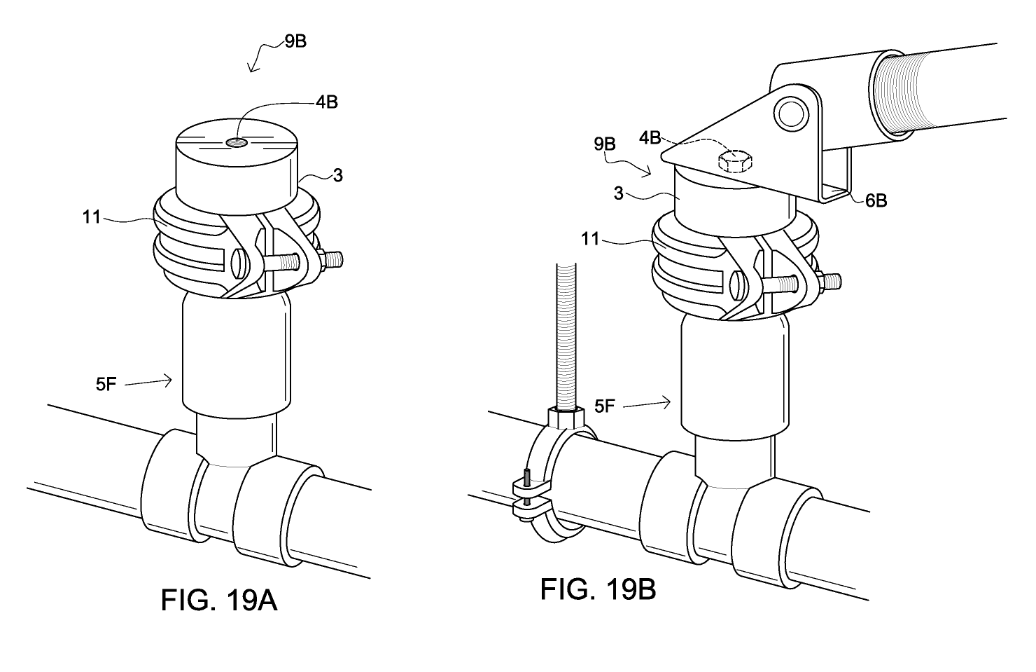

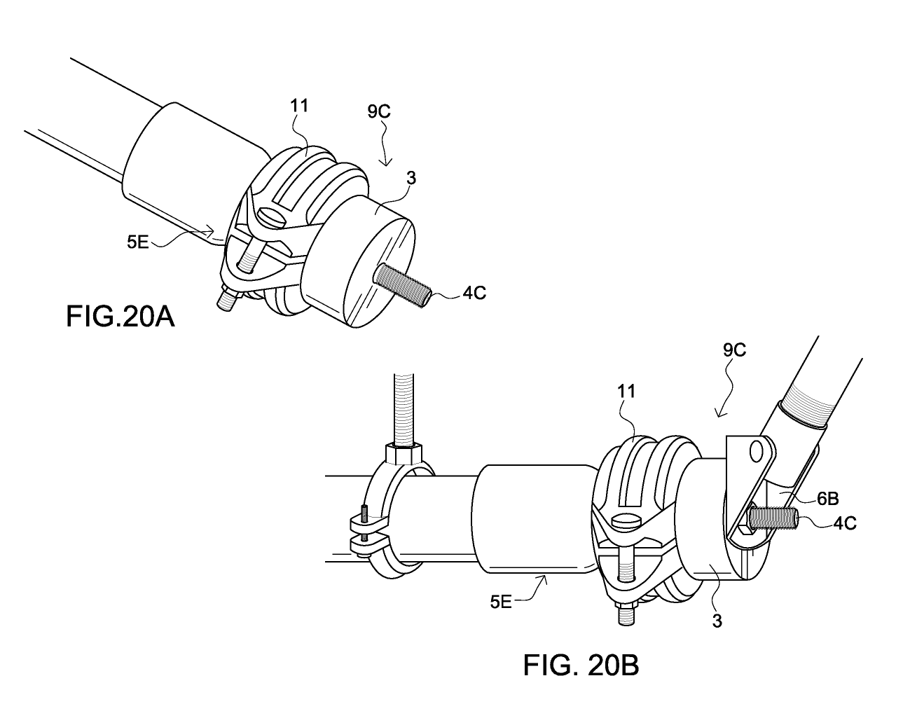

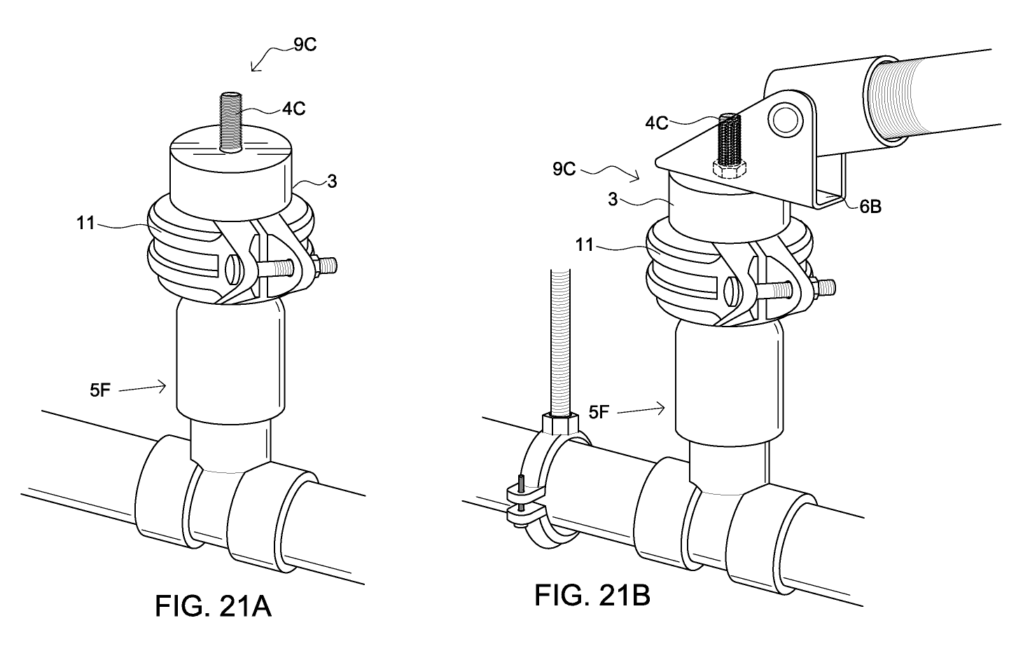

Refer to FIGS. 15A-21B. In this embodiment, the apparatus 15A, 15B, 15C is comprised of a solid plug element which is circumferentially grooved 10 on one end about the plug's 15A, 15B, 15C longitudinal axis. It should be appreciated to those ordinarily skilled in the art that some in the art prefer to label this “plug” as a “cap” instead; however, for simplicity, this embodiment will only refer to the term “plug” even though a “cap” would also be encompassed by this embodiment. In general, the plug's grooved end 10, 10A is adapted to engage a piping opening 5E, 5F that also has a circumferential groove disposed near the piping opening 5E, 5F, and be fixedly and sealing attached to the piping opening using a mechanical groove coupling 11 equipped with an elastomeric seal.

The standard for groove type and size for the plugs 15a, 15B, 15C can be based on any industry standard roll groove specifications, any industry standard cut groove specifications, or based on system/vendor-specific specifications. In some variations, the circumferentially disposed groove 10 is defined only on one side of the groove 10; that is, the plug member 15a, 15B, 15C has only a radially extended lip 10A that defines the groove 10 on the side adapted to engage a piping outlet 5E, 5F. In yet other variations, the circumferentially disposed groove is defined on both sides of the groove 10 by two radially extended lips 3, 10A. For example, Tyco Fire & Building Products manufactures grooved couplings between pipes, and publishes a set of groove specifications, which are available at http://www.tyco-fire.com/TD_TFP/TFP/IH_{—}1000FP_{—}08_{—}2007.pdf. Another example is the set of groove specifications published by Anvil International® for its GRUVLOK® line of products, which are available at http://www.anvilintl.com/SharedContent/Pdf/Literature_ProductBrochures/3006_{—}3006C_GrooverManual.pdf. Yet another example is provided by SHURJOINT®, whose piping groove specifications can be found at http://www.shurjoint.com/eng/files/literature/Shurjoint_Handbook-2009.pdf. Still other examples of piping groove specifications are published by Victaulic®, and are available at http://www.victaulic.com/Docs/lit/25.01.pdf, and at http://www.victaulic.com/Docs/lit/25.02.pdf. Of course, one skilled in the art will appreciate that many other piping-groove specifications may be used in conjunction with the general inventive concept of this embodiment, and accordingly are intended to be included in this disclosure.

In an embodiment, the plug member 15A, 15B, 15C extends beyond the grooved-engagement portion 10, 10A in a geometric shape that serves as a gripping section 3, which can be used to help manipulate the grooved coupling with the piping outlet or fitting 5E, 5F. In many embodiments, this geometrically-shaped gripping section 3 can be round, square, hexagonal, pentagonal, or any other shape which will allow a tool to grip and manipulate the plug member 15A, 15B, 15C.

In still other embodiments, the apparatus 15A, 15B, 15C has a means to attach and fasten an external motion-restraining device 6A, 6B to the plug member 15A, 15B, 15C. In some embodiments, the external motion-restraining device 6A, 6B can be a seismic brace or restraint (e.g., a mechanical, hydraulic, or pneumatic snubber, a sway brace, etc.), which, when attached to the plug member 15A, 15B, 15C, inhibits or prevents undesired movement of the associated piping system.

In a variation of this embodiment, the attachment means 4A, 4B, 4C between the plug member 15A, 15B, 15C and the external motion-restraining device 6A, 6B is a tab or “ear” 4A that can be welded to, machined from, or formed as part of the plug member 15A. Preferably, this tab or ear 4A is configured to be substantially perpendicular to the exposed end of the plug element 15A and substantially centered on the plug member 15A. The tab or ear 4A should be of sufficient size and thickness to provide for the applied seismic loads it will expect to see based upon the size of the grooved plug member 15A. The tab or ear 4A will have a drilled, bored, or formed hole disposed substantially in the center of the tab or ear 4A with the size of the hole corresponding to the applied seismic load, and the expected size of the fastener (such as, e.g., a through-bolt) to be used to connect the external brace or motion restraint 6A, 6B to the tab or ear 4A.

In another variation of this embodiment, the attachment means 4A, 4B, 4C between the plug member 15A, 15B, 15C and the external motion-restraining device 6A, 6B is a tapped hole 4B into the exposed end of the solid plug member 15B, using a compatible thread such that a threaded fastener, such as a bolt, may be screwed into the plug member 15B in order to attach and secure an external seismic brace or restraint 6A, 6B. The size of the tapped bolt hole 4B should correspond to the size of the plug member 15B and the expected applied seismic load or the required threaded fastener size for the external brace or restraint element 6A, 6B to be attached. In some embodiments, this tapped hole 4b can be drilled and tapped, machined, or formed/cast into the plug member 15B.

In yet another variation of this embodiment, the attachment means 4A, 4B, 4C between the plug member 15A, 15B, 15C and the external motion-restraining device 6A, 6B is a threaded stud 4C substantially centered into the exposed end of the plug member 15C. The size and thread type should correspond to the expected applied seismic loads, to the corresponding size of the plug member 15C, and to the required bolt size for the brace or restraint element 6A, 6B to be attached to the plug member 15C. The stud thread 4C should extend from the plug 15C sufficiently to allow the brace or restraint device 6A, 6B to be attached using any compatible and appropriately sized nut.

The alternatives offered by the device allow many and varied manufacturers' products to be attached without modification. These products can be used for their intended purpose and attached to the pipe, piping system, fitting, or outlet 5E, 5F in a quick, affordable manner using standard or readily available hardware.

### Fourth Embodiment

### A Method of Making an Apparatus for Supporting Industrial Piping

Referring to FIGS. 1A-21B, this embodiment encompasses a method of making an apparatus that can be used to support industrial piping, wherein the method comprises the steps of:
Providing a pipe-fitting-attachment device 1A, 1B, 1C, 7A, 7B, 7C, 15A, 15B, 15C;
Providing a first attachment interface 2, 8, 10/10A on the pipe-fitting-attachment device 1A, 1B, 1C, 7A, 7B, 7C, 15A, 15B, 15C, wherein the first attachment interface is adapted to directly and sealingly couple to a pipe opening 5A, 5B, 5C, 5D, 5E, 5F on a piping system;
Providing a second attachment interface 4A, 4B, 4C on the pipe-fitting-attachment device 1A, 1B, 1C, 7A, 7B, 7C, 15A, 15B, 15C, wherein the second attachment interface 4A, 4B, 4C is adapted to directly couple to an external restraining structure 6A, 6B for restricting the movement of the piping system; and
Providing a gripping section 3 on the pipe-fitting-attachment device 1A, 1B, 1C, 7A, 7B, 7C, 15A, 15B, 15C, wherein the gripping section 3 is coupled to both the first attachment interface 2, 8, 10/10A and to the second attachment interface 4A, 4B, 4C;
Wherein the first attachment interface 2, 8, 10/10A, second interface 4A, 4B, 4C, and gripping section 3 are substantially longitudinally aligned with each other on the pipe-fitting-attachment device 1A, 1B, 1C, 7A, 7B, 7C, 15A, 15B, 15C.

This embodiment can be further enhanced wherein the pipe-fitting-attachment device 1A, 1B, 1C is a plug whose first attachment interface 2, 8, 10/10A comprises male threads 2 adapted to engage female threads in a piping opening 5A, 5B. In some variations, the male threads 2 conform to a standard selected from the group consisting of National Pipe Thread, metric standard thread, and system-specific thread.

This embodiment can be further enhanced wherein the pipe-fitting-attachment device 7A, 7B, 7C is a cap whose first attachment interface 8 is a substantially hollowed-out section that contains female threads 8 adapted to engage male threads disposed at the end of a piping opening 5C, 5D. In some variations, the female threads 8 conform to a standard selected from the group consisting of National Pipe Thread, metric standard thread, and system-specific thread.

This embodiment can be further enhanced wherein the pipe-fitting-attachment device 15A, 15B, 15C has a first attachment interface 10/10A comprising a circumferentially grooved end 10/10A adapted to engage a piping opening 5E, 5F that also has a circumferential groove disposed near the piping opening 5E, 5F; and be fixedly and sealing attached to a piping opening 5E, 5F using a mechanical groove coupling 11 equipped with an elastomeric seal. In some variations, the circumferentially grooved end 10/10A has a roll groove or cut groove that conforms to a standard selected from the group consisting of English, metric, and system-specific groove specification.

This embodiment can be further enhanced wherein the gripping section 3 on the pipe-fitting-attachment device 1A, 1B, 1C, 7A, 7B, 7C, 15A, 15B, 15C has a geometric shape selected from the group consisting of round, square, hexagonal, and pentagonal.

This embodiment can be further enhanced wherein the second attachment interface 4A, 4B, 4C is selected from the group consisting of a threaded stud 4C, a threaded tap 4B, and a tab with a hole disposed within it 4A.

This embodiment can be further enhanced wherein the second attachment interface 4A, 4B, 4C is disposed substantially perpendicular to the outer face of the gripping member 3 and is substantially centered relative to the outer face of the gripping member 3.

### Fifth Embodiment

### A Method of Using a Piping-Support Apparatus

Referring to FIGS. 1A-21B, this embodiment encompasses a method of using an apparatus that can be used to support industrial piping, wherein the method comprises the steps of:
Selecting a target pipe to be subjected to motion restraint 6A, 6B;
For an opening 5A, 5B, 5C, 5D, 5E, 5F in the target pipe, determining the necessary piping-opening coupling scheme between the piping opening 5A, 5B, 5C, 5D, 5E, 5F and the first attachment interface 2, 8, 10/10A of the pipe-fitting-attachment device 1A, 1B, 1C, 7A, 7B, 7C, 15A, 15B, 15C of the piping-support apparatus according to the First, Second, Third, or Fourth Embodiments, described supra;
Obtaining an appropriate pipe-fitting-attachment device 1A, 1B, 1C, 7A, 7B, 7C, 15A, 15B, 15C according to First, Second, Third, or Fourth Embodiments, described supra, that has a size compatible with said piping opening 5A, 5B, 5C, 5D, 5E, 5F and that corresponds to said determined coupling scheme;
As necessary, applying sealant medium to the coupling surfaces of the first attachment interface 2, 8, 10/10A and the piping opening 5A, 5B, 5C, 5D, 5E, 5F;
Inserting the first attachment interface 2, 8, 10/10A into, or onto, depending on the type of first-attachment interface 2, 8, 10/10A, the piping opening 5A, 5B, 5C, 5D, 5E, 5F until the pipe-fitting-attachment device 1A, 1B, 1C, 7A, 7B, 7C, 15A, 15B, 15C is fixedly coupled to the piping opening 5A, 5B, 5C, 5D, 5E, 5F; and
Coupling the second attachment interface 4A, 4B, 4C of the pipe-fitting-attachment device 1A, 1B, 1C, 7A, 7B, 7C, 15A, 15B, 15C to an external restraining structure 6A, 6B for restricting the movement of the piping system.

This embodiment can be further enhanced wherein the first attachment interface 2 comprises male threads 2 adapted to engage female threads in a piping opening 5A, 5B, or wherein the first attachment interface 8 comprises female threads adapted to engage male threads on a piping opening 5C, 5D, and further comprises the step of tightening the coupling between the piping opening 5A, 5B, 5C, 5D and the first attachment interface 2, 8 by applying torque to the gripping section 3 of the pipe-fitting-attachment device 1A, 1B, 1C, 7A, 7B, 7C to cause further thread engagement.

This embodiment can be further enhanced wherein the male or female threads of the first attachment interface 2, 8 conform to a standard selected from the group consisting of National Pipe Thread, metric standard thread, and system-specific thread.

This embodiment can be further enhanced wherein the first attachment interface 10/10A comprises a circumferentially grooved end 10/10A adapted to engage a piping opening 5E, 5F that also has a circumferential groove disposed near the piping opening 5E, 5F; and be fixedly and sealing attached to the piping opening 5E, 5F using a mechanical groove coupling 11 equipped with an elastomeric seal; the method further comprising the steps of:
Attaching a mechanical groove coupling 11 over the circumferential groove 10/10A of the first attachment interface 10/10A and the circumferential groove disposed near the piping opening 5E, 5F; and
Tightening the mechanical groove coupling 11 fasteners to establish a seal.

This embodiment can be further enhanced wherein the circumferentially grooved end 10/10A has a roll groove or cut groove that conforms to a standard selected from the group consisting of English, metric, and system-specific groove specification.

This embodiment can be further enhanced wherein the gripping section 3 on the pipe-fitting-attachment device 1A, 1B, 1C, 7A, 7B, 7C, 15A, 15B, 15C has a geometric shape selected from the group consisting of round, square, hexagonal, and pentagonal.

This embodiment can be further enhanced wherein the second attachment interface 4A, 4B, 4C is selected from the group consisting of a threaded stud 4C, a threaded tap 4B, and a tab with a hole disposed within it 4A.

This embodiment can be further enhanced wherein the second attachment interface 4A, 4B, 4C is disposed substantially perpendicular to the outer face of the gripping member 3 and is substantially centered relative to the outer face of the gripping member 3.

This embodiment can be further enhanced wherein the external restraining structure 6A, 6B is a seismic brace. In some variations, the seismic brace includes a snubber of a type selected from the group consisting of mechanical, hydraulic, and pneumatic.

This embodiment can be further enhanced wherein the external restraining structure 6A, 6B is a non-seismic-rated restraint.

This embodiment can be further enhanced wherein the second attachment interface 4A, 4B, 4C is a threaded stud 4C, and the step for coupling said second attachment interface 4C to the external restraining structure 6A, 6B includes installing and tightening a nut onto the threaded stud 4C to establish the coupling.

This embodiment can be further enhanced wherein the second attachment interface 4A, 4B, 4C is a threaded tap 4B, and the step for coupling the second attachment interface 4B to the external restraining structure 6A, 6B includes installing and tightening a bolt into the threaded tap 4B to establish the coupling.

This embodiment can be further enhanced wherein the second attachment interface 4A, 4B, 4C is a tab with a hole disposed within it 4A, and the step for coupling the second attachment interface 4A to the external restraining structure 6A, 6B includes installing and tightening a bolt-and-nut set through the tab hole 4A to fix a mating surface on the external restraining structure 6A, 6B to establish the coupling.

### Sixth Embodiment

### A System of Motion Restraints Installed on an Industrial-Piping System

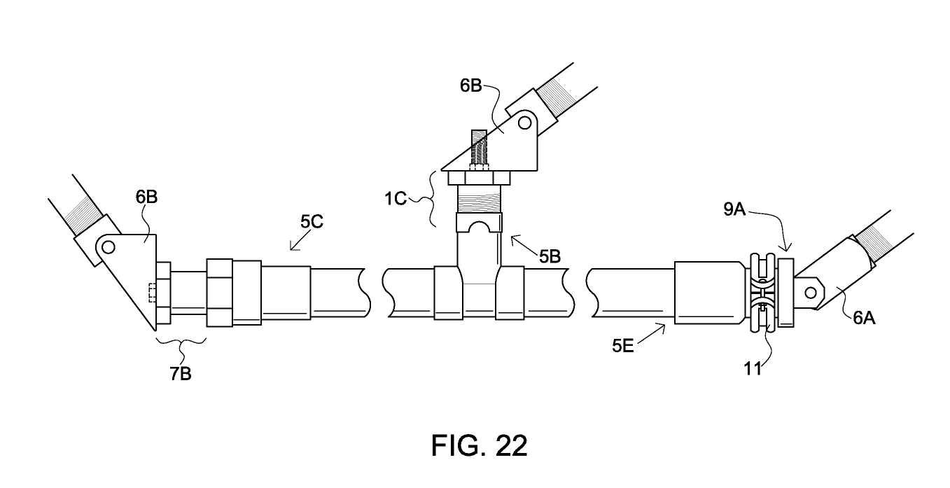

This embodiment is directed generally to a system of motion restraints installed on an industrial-piping system. Refer to FIG. 22, as well as FIGS. 1A-21B in support of FIG. 22. The system of motion restraints comprises:
A first piping-support apparatus 1A, 1B, 1C configured according to the First Embodiment, discussed supra, coupled at the first attachment interface 2 with a first piping-system outlet member 5A, 5B equipped with female threads, and coupled at the second attachment interface 4A, 4B, 4C with a first external restraining structure 6A, 6B for restricting the movement of the piping system;
A second piping-support apparatus 7A, 7B, 7C configured according to the Second Embodiment, discussed supra, coupled at the first attachment interface 8 with a second piping-system outlet member 5C, 5D equipped with male threads, and coupled at the second attachment interface 4A, 4B, 4C with a second external restraining structure 6A, 6B for restricting the movement of the piping system; and
A third piping-support apparatus 15A, 15B, 15C configured according to the Third Embodiment, discussed supra, coupled at the first attachment interface 10/10A, 11 with a third piping-system outlet member 5E, 5F equipped with a circumferential coupling groove, and coupled at the second attachment interface 4A, 4B, 4C with a third external restraining structure 6A, 6B for restricting the movement of the piping system.

This embodiment is can be further enhanced wherein each of the second attachment interfaces 4A, 4B, 4C is selected from the group consisting of a threaded stud 4C, a threaded tap 4B, and a tab with a hole disposed within it 4A.

### Seventh Embodiment

### A Method of Making a System of Motion Restraints Installed on an Industrial-Piping System

This embodiment is directed generally to a method of making a system of motion restraints installed on an industrial-piping system. Refer to FIG. 22, as well as FIGS. 1A-21B in support of FIG. 22. The method comprises the steps of:
Providing a first piping-support apparatus 1A, 1B, 1C configured according to the First Embodiment, discussed supra;
Coupling the first piping-support apparatus 1A, 1B, 1C at its first attachment interface 2 with a first piping-system outlet member 5A, 5B equipped with female threads;
Coupling the first piping-support apparatus 1A, 1B, 1C at its second attachment interface 4A, 4B, 4C with a first external restraining structure 6A, 6B for restricting the movement of the piping system;
Providing a second piping-support apparatus 7A, 7B, 7C configured according to the Second Embodiment, discussed supra;
Coupling the second piping-support apparatus 7A, 7B, 7C at its first attachment interface 8 with a second piping-system outlet member 5C, 5D equipped with male threads;
Coupling the second piping-support apparatus 7A, 7B, 7C at its second attachment interface 4A, 4B, 4C with a second external restraining structure 6A, 6B for restricting the movement of the piping system;
Providing a third piping-support apparatus 15A, 15B, 15C configured according to the Third Embodiment, discussed supra;
Coupling the third piping-support apparatus 15A, 15B, 15C at its first attachment interface 10/10A with a third piping-system outlet member 5E, 5F equipped with a circumferential coupling groove; and
Coupling the third piping-support apparatus 15A, 15B, 15C at its second attachment interface 10/10A with a third external restraining structure 5E, 5F for restricting the movement of the piping system.

This embodiment is can be further enhanced wherein each of the second attachment interfaces 4A, 4B, 4C is selected from the group consisting of a threaded stud 4C, a threaded tap 4B, and a tab with a hole disposed within it 4A.

### Alternative Embodiments and Other Variations

The various embodiments and variations thereof described herein and/or illustrated in the accompanying Figures are merely exemplary and are not meant to limit the scope of the inventive disclosure. It should be appreciated that numerous variations of the invention have been contemplated as would be obvious to one of ordinary skill in the art with the benefit of this disclosure.

Hence, those ordinarily skilled in the art will have no difficulty devising myriad obvious variations and improvements to the invention, all of which are intended to be encompassed within the scope of the claims which follow.

What is claimed is:

1. An apparatus that can be used to support industrial piping, comprising:
a pipe-fitting-attachment device;
a first attachment interface on said pipe-fitting-attachment device,
wherein said first attachment interface is adapted to directly and sealingly couple to a pipe opening on a piping system;
a second attachment interface on said pipe-fitting-attachment device,
wherein said second attachment interface is adapted to directly couple to an external restraining structure for restricting the movement of said piping system; and
a gripping section on said pipe-fitting-attachment device,
wherein said gripping section is coupled to both said first attachment interface and to said second attachment interface;
wherein said first attachment interface, second interface, and gripping section are substantially longitudinally aligned with each other on said pipe-fitting-attachment device.

2. The apparatus of claim 1, wherein said first attachment interface comprises male threads adapted to engage female threads in a piping opening.

3. The apparatus of claim 2, wherein said male threads conform to a standard selected from the group consisting of National Pipe Thread, metric standard thread, and system-specific thread.

4. The apparatus of claim 1, wherein said pipe-fitting-attachment device's first attachment interface is a substantially hollowed-out section that contains female threads adapted to engage male threads disposed at the end of a piping opening.

5. The apparatus of claim 4, wherein said female threads conform to a standard selected from the group consisting of National Pipe Thread, metric standard thread, and system-specific thread.

6. The apparatus of claim 1, wherein said first attachment interface comprises a circumferentially grooved end adapted to:
engage a piping opening that also has a circumferential groove disposed near said piping opening; and
be fixedly and sealing attached to said piping opening using a mechanical groove coupling equipped with an elastomeric seal.

7. The apparatus of claim 6, wherein said circumferentially grooved end has a roll or cut groove that conforms to a standard selected from the group consisting of English, metric, and system-specific groove specification.

8. The apparatus of claim 1, wherein said gripping section on said pipe-fitting-attachment device has a geometric shape selected from the group consisting of round, square, hexagonal, and pentagonal.

9. The apparatus of claim 1, wherein said second attachment interface is selected from the group consisting of a threaded stud, a threaded tap, and a tab with a hole disposed within it.

10. The apparatus of claim 9, wherein said second attachment interface is disposed substantially perpendicular to the outer face of said gripping member and is substantially centered relative to said outer face of said gripping member.

11. A method of making an apparatus that can be used to support industrial piping, comprising the steps of:
providing a pipe-fitting-attachment device;
providing a first attachment interface on said pipe-fitting-attachment device,
wherein said first attachment interface is adapted to directly and sealingly couple to a pipe opening on a piping system;
providing a second attachment interface on said pipe-fitting-attachment device,
wherein said second attachment interface is adapted to directly couple to an external restraining structure for restricting the movement of said piping system; and
providing a gripping section on said pipe-fitting-attachment device,
wherein said gripping section is coupled to both said first attachment interface and to said second attachment interface;
wherein said first attachment interface, second interface, and gripping section are substantially longitudinally aligned with each other on said pipe-fitting-attachment device.

12. The method of claim 11, wherein said first attachment interface comprises male threads adapted to engage female threads in a piping opening.

13. The method of claim 12, wherein said male threads conform to a standard selected from the group consisting of National Pipe Thread, metric standard thread, and system-specific thread.

14. The method of claim 11, wherein said pipe-fitting-attachment device's first attachment interface is a substantially hollowed-out section that contains female threads adapted to engage male threads disposed at the end of a piping opening.

15. The method of claim 14, wherein said female threads conform to a standard selected from the group consisting of National Pipe Thread, metric standard thread, and system-specific thread.

16. The method of claim 11, wherein said first attachment interface comprises a circumferentially grooved end adapted to:
engage a piping opening that also has a circumferential groove disposed near said piping opening; and
be fixedly and sealing attached to a piping opening using a mechanical groove coupling equipped with an elastomeric seal.

17. The method of claim 16, wherein said circumferentially grooved end has a roll or cut groove that conforms to a standard selected from the group consisting of English, metric, and system-specific groove specification.

18. The method of claim 11, wherein said gripping section on said pipe-fitting-attachment device has a geometric shape selected from the group consisting of round, square, hexagonal, and pentagonal.

19. The method of claim 11, wherein said second attachment interface is selected from the group consisting of a threaded stud, a threaded tap, and a tab with a hole disposed within it.

20. The method of claim 19, wherein said second attachment interface is disposed substantially perpendicular to the outer face of said gripping member and is substantially centered relative to said outer face of said gripping member.

21. A method of using a piping-support apparatus according to claim 1, said method comprising the steps of:
selecting a target pipe to be subjected to motion restraint;
for an opening in said target pipe, determining the necessary piping-opening coupling scheme between said piping opening and the first attachment interface of said piping-support apparatus according to claim 1;
obtaining a piping-support apparatus according to claim 1 that has a size compatible with said piping opening and that corresponds to said determined coupling scheme;
inserting said first attachment interface into, or onto, depending on the type of first-attachment interface, said piping opening until said piping-support apparatus is fixedly coupled to said piping opening; and
coupling the second attachment interface of said piping-support apparatus to an external restraining structure for restricting the movement of said piping system.

22. The method of claim 21, further comprising the step of, before the step of inserting said first attachment interface, applying sealant medium to the coupling surfaces of said first attachment interface and said piping opening.

23. The method of claim 21, wherein said first attachment interface comprises male threads adapted to engage female threads in a piping opening, or wherein said first attachment interface comprises female threads adapted to engage male threads on a piping opening, and further comprising the step of:
tightening the coupling between said piping opening and said first attachment interface by applying torque to the gripping section of said piping-support apparatus to cause further thread engagement.

24. The method of claim 23, wherein said male threads conform to a standard selected from the group consisting of National Pipe Thread, metric standard thread, and system-specific thread.

25. The method of claim 21, wherein said first attachment interface comprises a circumferentially grooved end adapted to:
engage a piping opening that also has a circumferential groove disposed near said piping opening; and
be fixedly and sealing attached to said piping opening using a mechanical groove coupling equipped with an elastomeric seal;
the method further comprising the steps of:
attaching a mechanical groove coupling over said circumferential groove of said first attachment interface and said circumferential groove disposed near said piping opening; and
tightening mechanical groove coupling fasteners to establish a seal.

26. The method of claim 25, wherein said circumferentially grooved end has a roll or cut groove that conforms to a standard selected from the group consisting of English, metric, and system-specific groove specification.

27. The method of claim 21, wherein said gripping section on said piping-support apparatus has a geometric shape selected from the group consisting of round, square, hexagonal, and pentagonal.

28. The method of claim 21, wherein said second attachment interface is selected from the group consisting of a threaded stud, a threaded tap, and a tab with a hole disposed within it.

29. The method of claim 28, wherein said second attachment interface is disposed substantially perpendicular to the outer face of said gripping member and is substantially centered relative to said outer face of said gripping member.

30. The method of claim 21, wherein said external restraining structure is a seismic brace.

31. The method of claim 30, wherein said seismic brace includes a snubber of a type selected from the group consisting of mechanical, hydraulic, and pneumatic.

32. The method of claim 21, wherein said external restraining structure is a non-seismic-rated restraint.

33. The method of claim 28, wherein said second attachment interface is a threaded stud, and the step for coupling said second attachment interface to said external restraining structure includes installing and tightening a nut onto said threaded stud to establish said coupling.

34. The method of claim 28, wherein said second attachment interface is a threaded tap, and the step for coupling said second attachment interface to said external restraining structure includes installing and tightening a bolt into said threaded tap to establish said coupling.

35. The method of claim 28, wherein said second attachment interface is a tab with a hole disposed within it, and the step for coupling said second attachment interface to said external restraining structure includes installing and tightening a bolt-and-nut set through said tab hole to fix a mating surface on said external restraining structure to establish said coupling.

36. A system of motion restraints installed on an industrial-piping system, comprising:
a first piping-support apparatus, comprising:
a first attachment interface,
wherein said first attachment interface is adapted to directly and sealingly couple to a pipe opening on a piping system,
a second attachment interface,
wherein said second attachment interface is adapted to directly couple to an external restraining structure for restricting the movement of said piping system, and
a gripping section,
wherein said gripping section is coupled to both said first attachment interface and to said second attachment interface,
wherein said first piping-support apparatus' first attachment interface, second interface, and gripping section are substantially longitudinally aligned with each other,
wherein said first piping-support apparatus' first attachment interface comprises male threads adapted to engage female threads in a piping opening, and
wherein said first piping-support apparatus is coupled at its first attachment interface with a first piping-system outlet member equipped with female threads, and coupled at its second attachment interface with a first external restraining structure for restricting the movement of said piping system;
a second piping-support apparatus, comprising:
a first attachment interface,
wherein said first attachment interface is adapted to directly and sealingly couple to a pipe opening on a piping system,
a second attachment interface,
wherein said second attachment interface is adapted to directly couple to an external restraining structure for restricting the movement of said piping system, and
a gripping section,
wherein said gripping section is coupled to both said first attachment interface and to said second attachment interface,
wherein said second piping-support apparatus' first attachment interface, second interface, and gripping section are substantially longitudinally aligned with each other,
wherein said second piping-support apparatus' first attachment interface is a substantially hollowed-out section that contains female threads adapted to engage male threads disposed at the end of a piping opening, and
wherein said second piping-support apparatus is coupled at its first attachment interface with a second piping-system outlet member equipped with male threads, and coupled at its second attachment interface with a second external restraining structure for restricting the movement of said piping system; and
a third piping-support apparatus, comprising:
a first attachment interface,
wherein said first attachment interface is adapted to directly and sealingly couple to a pipe opening on a piping system,
a second attachment interface,
wherein said second attachment interface is adapted to directly couple to an external restraining structure for restricting the movement of said piping system, and
a gripping section,
wherein said gripping section is coupled to both said first attachment interface and to said second attachment interface,
wherein said third piping-support apparatus' first attachment interface, second interface, and gripping section are substantially longitudinally aligned with each other,
wherein said third piping-support apparatus' first attachment interface comprises a circumferentially grooved end adapted to:
engage a piping opening that also has a circumferential groove disposed near said piping opening; and
be fixedly and sealing attached to said piping opening using a mechanical groove coupling equipped with an elastomeric seal, and
wherein said third piping-support apparatus is coupled at its first attachment interface with a third piping-system outlet member equipped with a circumferential coupling groove, and coupled at its second attachment interface with a third external restraining structure for restricting the movement of said piping system.

37. The system of claim 36, wherein each of said second attachment interfaces is selected from the group consisting of a threaded stud, a threaded tap, and a tab with a hole disposed within it.

38. A method of making a system of motion restraints installed on an industrial-piping system, comprising the steps of:
providing a first piping-support apparatus comprising:
a first attachment interface,
wherein said first attachment interface is adapted to directly and sealingly couple to a pipe opening on a piping system,
a second attachment interface,
wherein said second attachment interface is adapted to directly couple to an external restraining structure for restricting the movement of said piping system, and
a gripping section,
wherein said gripping section is coupled to both said first attachment interface and to said second attachment interface,
wherein said first piping-support apparatus' first attachment interface, second interface, and gripping section are substantially longitudinally aligned with each other, and
wherein said first piping-support apparatus' first attachment interface comprises male threads adapted to engage female threads in a piping opening;
coupling said first piping-support apparatus at its first attachment interface with a first piping-system outlet member equipped with female threads;
coupling said first piping-support apparatus at its second attachment interface with a first external restraining structure for restricting the movement of said piping system;
providing a second piping-support apparatus comprising:
a first attachment interface,
wherein said first attachment interface is adapted to directly and sealingly couple to a pipe opening on a piping system,
a second attachment interface,
wherein said second attachment interface is adapted to directly couple to an external restraining structure for restricting the movement of said piping system, and
a gripping section,
wherein said gripping section is coupled to both said first attachment interface and to said second attachment interface,
wherein said second piping-support apparatus' first attachment interface, second interface, and gripping section are substantially longitudinally aligned with each other, and
wherein said second piping-support apparatus' first attachment interface is a substantially hollowed-out section that contains female threads adapted to engage male threads disposed at the end of a piping opening;
coupling said second piping-support apparatus at its first attachment interface with a second piping-system outlet member equipped with male threads;
coupling said second piping-support apparatus at its second attachment interface with a second external restraining structure for restricting the movement of said piping system;
providing a third piping-support apparatus comprising:
a first attachment interface,
wherein said first attachment interface is adapted to directly and sealingly couple to a pipe opening on a piping system,
a second attachment interface,
wherein said second attachment interface is adapted to directly couple to an external restraining structure for restricting the movement of said piping system, and
a gripping section,
wherein said gripping section is coupled to both said first attachment interface and to said second attachment interface,
wherein said third piping-support apparatus' first attachment interface, second interface, and gripping section are substantially longitudinally aligned with each other, and
wherein said third piping-support apparatus' first attachment interface comprises a circumferentially grooved end adapted to:
engage a piping opening that also has a circumferential groove disposed near said piping opening; and
be fixedly and sealing attached to said piping opening using a mechanical groove coupling equipped with an elastomeric seal;
coupling said third piping-support apparatus at its first attachment interface with a third piping-system outlet member equipped with a circumferential coupling groove; and
coupling said third piping-support apparatus at its second attachment interface with a third external restraining structure for restricting the movement of said piping system.

39. The method of claim 38, wherein each of said second attachment interfaces is selected from the group consisting of a threaded stud, a threaded tap, and a tab with a hole disposed within it.
